(19) United States
(12) Patent Application Publication
(10) Pub. No.: US 2023/0268116 A1
(43) Pub. Date: Aug. 24, 2023

(54) TRANSFORMER, AND METHOD FOR MANUFACTURING TRANSFORMER

(71) Applicant: Murata Manufacturing Co., Ltd., Nagaokakyo-shi (JP)

(72) Inventors: Gang LI, Hubei (CN); Yuanyuan YI, Hubei (CN)

(21) Appl. No.: 18/108,192

(22) Filed: Feb. 10, 2023

(30) Foreign Application Priority Data
Feb. 18, 2022 (JP) 202210151366.3

(51) Int. Cl. H01F 27/28; H01F 27/30; H01F 1/03; H01F 27/00; H01F 27/245; H01F 41/074

(52) U.S. Cl. CPC H01F 27/2804; H01F 1/0315; H01F 27/006; H01F 27/245; H01F 27/306; H01F 41/074; H01F 2027/2819

(57) ABSTRACT

Provided are a transformer and a method for manufacturing a transformer. The transformer includes a magnetic core including: a top substrate and a bottom substrate arranged opposite to each other, and a plurality of winding posts located therebetween; and a winding including a primary side winding wrapped around the plurality of winding posts and a secondary side winding. The primary side winding includes two sub-windings connected in parallel, each including: a main turn including respective at least one turn wrapped on at least two winding posts, respectively, and the at least two winding posts have a single magnetic flux direction; and an additional turn including at least one turn wrapped on at least one additional winding post on which a corresponding main turn of the other sub-winding wraps, and the additional turn has a magnetic flux direction opposite to the single magnetic flux direction.

### CROSS REFERENCE TO RELATED APPLICATIONS

The application claims priority to Chinese Patent Application No. 202210151366.3 filed on Feb. 18, 2022, in the China National Intellectual Property Administration, the whole disclosure of which is incorporated herein by reference in its entirety.

### BACKGROUND OF THE INVENTION

### 1. Field of the Invention

The present disclosure relates to the field of transformer technology, and in particular, to a transformer and a method for manufacturing the transformer (especially a method of wrapping a winding of the transformer). More particularly, the present disclosure relates to a transformer having a required odd or even turn ratio and a method of wrapping a primary side winding in the transformer having the required odd or even turn ratio.

### 2. Description of the Related Art

A transformer is a device that uses an electromagnetic mutual induction to transform a voltage, a current, and an impedance. A transformer includes a magnetic core and a winding, and the winding is divided into a primary side winding and a secondary side winding. A transformation ratio K = (a number of turns of the primary side winding Np) / (a number of turns of the secondary side winding Ns), K>0, that is, the transformation ratio is generally also referred to as a turn ratio (of the primary side winding with respect to the secondary side winding). When a transformer is designed, according to requirements of an input voltage and an output voltage, different values are selected as the transformation ratio K. That is, when a transformer is designed, the K value is determined by design requirements. Based on the K value, when selecting a number of turns of a winding, selections of the number Np of turns of the primary side winding and the number Ns of turns of the secondary side winding are various.

With the continuous progress and breakthrough of the magnetic integration technology, related applications and technical researches on a transformer (especially a planar transformer) including a winding with wrapped coils have attracted more and more attention. A biggest difference between the transformer, especially a planar transformer, including a winding with wrapped coils, and a conventional transformer lies in a difference in windings. Typically, multiple layers of printed circuit boards (PCBs) covered with conductive foils (usually copper foils) are stacked to form a winding of a planar transformer. Specifically, for example, a printed circuit board manufacturing process is used in the transformer, especially a planar transformer, including a winding with wrapped coils, so as to form spiral coils on the multi-layer board, and the spiral coils of different layers are connected to form a primary winding (i.e. primary side winding) or a secondary winding (i.e. secondary side winding). Due to a special planar structure and a tight coupling of windings, copper foil wirings inside a multi-layer PCB are used as a winding of a planar transformer, which has advantages of flexible winding design, simple assembly, and the like, greatly reducing a volume and a height of the transformer, improving a high power density, so that a power module may be miniaturized and planarized. In addition, high frequency parasitic parameters are significantly reduced, and a working state of a switching power supply is greatly improved.

A number of turns of a winding of a transformer including a winding with wrapped coils is an important factor affecting a performance of the transformer. At present, in the transformer including the winding with wrapped coils, a connection manner of forming a primary side winding or a secondary side winding is relatively simple. Common numbers of turns of windings, especially the numbers of turns of a primary side winding and a secondary side winding, have a corresponding turn ratio of, for example, an even number. Therefore, how to achieve odd-numbered turns of winding in the transformer including the winding with wrapped coils, and an odd-numbered turn ratio/transformation ratio is an urgent technical problem to be solved. Alternatively, in other words, the urgent problem to be solved is how to achieve an expected number of turns of a primary side winding, or a primary side-secondary side equivalent turn ratio, no matter an odd number or an even number is desired. In addition, a loss of the transformer will result in an increase in a heat consumption density of a power supply when a power of the power supply increases. Correspondingly, a power supply with high power is required to meet heat dissipation requirements, thereby restricting an increase in a power density of the power supply.

### SUMMARY OF THE INVENTION

In order to solve at least one aspect of the above-mentioned problems and defects existing in the related art, preferred embodiments of the present invention provide a transformer and a method for manufacturing a transformer.

According to a first preferred embodiment of the present invention, a transformer is provided, including: a magnetic core, including: a top substrate and a bottom substrate arranged opposite to each other; and a plurality of winding posts located between the top substrate and the bottom substrate; and a winding, including a primary side winding and a secondary side winding, wherein the primary side winding wraps around the plurality of winding posts, the primary side winding includes at least one pair of sub-windings, each pair of sub-windings includes two sub-windings connected in parallel, and each sub-winding in each pair of sub-windings includes: a main turn, including respective at least one turn wrapping on at least two winding posts, respectively, wherein a current flowing through the main turn forms a main turn magnetic flux along a first magnetic flux direction on the at least two winding posts; and an additional turn, including at least one turn reversely wrapping on at least one additional winding post with respect to the main turn, wherein the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post, wherein in each pair of sub-windings, a current of at least one main turn of each sub-winding is shunted to at least one additional turn of a same sub-winding, and a magnetic flux loss caused by a current shunting on the main turn of each sub-winding is compensated by a magnetic flux generated by a corresponding additional turn wrapping around the at least one main turn of the other sub-winding of the pair of sub-windings.

According to the preferred embodiments of the present invention, the plurality of winding posts include 4T winding posts, and T is a positive integer; and wherein the primary side winding includes one pair of sub-windings, and respective main turns of the pair of sub-windings respectively wrap on 2T winding posts different from each other, or the primary side winding includes at least two pairs of sub-windings, respective main turns of sub-windings defining a same magnetic flux direction in the at least two pairs of sub-windings are connected in parallel with each other, and respective main turns of two sub-windings in each pair of sub-windings respectively wrap on two winding posts different from each other.

According to the preferred embodiments of the present invention, the main turn of each sub-winding wraps by odd-numbered turns, and the additional turn of each sub-winding wraps by odd-numbered turns on at least one winding post different from the winding posts on which the main turn wraps.

According to the preferred embodiments of the present invention, the at least two winding posts include paired non-adjacent winding posts, each sub-winding in each pair of sub-windings includes at least one turn respectively wrapping on the paired non-adjacent winding posts, and required odd-numbered or even-numbered turns wrapping on a winding post adjacent to one of the paired non-adjacent winding posts, a magnetic flux direction on each pair of non-adjacent winding posts is the same, which is opposite to a magnetic flux direction on the winding post adjacent to the one of paired two non-adjacent winding posts.

According to the preferred embodiments of the present invention, the plurality of winding posts are four winding posts, and connecting lines of center points of the four winding posts form a virtual quadrangle, winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

According to the preferred embodiments of the present invention, the plurality of winding posts are arranged on at least one of the bottom substrate and the top substrate and extend toward the other of the bottom substrate and the top substrate, and each winding post includes an upper magnetic core and a lower magnetic core bonded together or integrally formed as a single magnetic post.

According to the preferred embodiments of the present invention, a short-circuit connection is arranged between respective points of two sub-windings of each pair of sub-windings arranged symmetrically and having an equal electric potential.

According to the preferred embodiments of the present invention, the primary side winding and the secondary side winding are arranged on multiple layers of the transformer at intervals, and respective portions of the primary side winding and the secondary side winding arranged on different layers provide an interlayer electrical communication to form an integral coil through connection in series or in parallel via a fly line passing through a via hole in at least one layer or a copper post connected among different layers.

According to the preferred embodiments of the present invention, the secondary side winding wraps around at least one winding post of the plurality of winding posts, and portions of the secondary side windings located on a same winding post wrap at intervals.

According to the preferred embodiments of the present invention, a cross section of each winding post is circular, oval, or polygon.

According to the preferred embodiments of the present invention, a magnetic reluctance of each winding post is the same.

According to the preferred embodiments of the present invention, a cross-sectional area of each winding post is the same.

According to the preferred embodiments of the present invention, each winding post is made of ferrite.

According to a second preferred embodiment of the present invention, a method for manufacturing a transformer is provided, the transformer including a magnetic core and a winding, the magnetic core including a top substrate and a bottom substrate arranged opposite to each other, and a plurality of winding posts located between the top substrate and the bottom substrate, and the winding including a primary side winding and a secondary side winding, wherein the method includes: preparing the magnetic core; and wrapping the winding of the transformer, including: wrapping the primary side winding on the plurality of winding posts, and wrapping the secondary side winding on at least one of the plurality of winding posts, wherein the wrapping the primary side winding on the plurality of winding posts includes: wrapping at least one pair of sub-windings, wherein each pair of sub-windings includes two sub-windings connected in parallel, and the wrapping at least one pair of sub-windings includes: wrapping a main turn, including respectively wrapping at least one turn on at least two winding posts, wherein a current flowing through the main turn forms a main turn magnetic flux along a first magnetic flux direction on the at least two winding posts; and wrapping an additional turn, including reversely wrapping at least one turn on at least one additional winding post with respect to the main turn, wherein the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post, wherein each pair of sub-windings wraps so that a current of at least one main turn of each sub-winding is shunted to at least one additional turn of a same sub-winding, and a magnetic flux loss caused by a current shunting on the main turn of each sub-winding is compensated by a magnetic flux generated by a corresponding additional turn wrapping on the at least one main turn of the other sub-winding of the pair of sub-windings.

According to the preferred embodiments of the present invention, the at least two winding posts include paired non-adjacent winding posts, each sub-winding in each pair of sub-windings includes at least one turn respectively wrapping on the paired non-adjacent winding posts, and required odd-numbered or even-numbered turns wrapping on a winding post adjacent to one of the paired non-adjacent winding posts, a magnetic flux direction on each pair of non-adjacent winding posts is the same, which is opposite to a magnetic flux direction on the winding post adjacent to the one of paired two non-adjacent winding posts.

According to the preferred embodiments of the present invention, the plurality of winding posts are four winding posts, and connecting lines of center points of the four winding posts define a virtual quadrangle, winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

According to the preferred embodiments of the present invention, a short-circuit connection is arranged between respective points of two sub-windings of each pair of sub-windings arranged symmetrically and having an equal electric potential.

According to the preferred embodiments of the present invention, the primary side winding and the secondary side winding are arranged on multiple layers of the transformer at intervals, and respective portions of the primary side winding and the secondary side winding arranged on different layers provide an interlayer electrical communication to form an integral coil through connection in series or in parallel via a fly line passing through a via hole in at least one layer or a copper post connected among different layers.

According to the preferred embodiments of the present invention, the secondary side winding wraps around at least one winding post of the plurality of winding posts, and portions of the secondary side windings located on a same winding post wrap at intervals.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 schematically shows an exploded view of a three-dimensional structure of a planar transformer according to a preferred embodiment of the present invention.

FIG. 2A illustrates a schematic structural view of a magnetic core of a planar transformer according to a preferred embodiment of the present invention, and a winding wrapping on the magnetic core is omitted for clarity.

FIG. 2B illustrates a schematic structural view of a magnetic core of a planar transformer according to another preferred embodiment of the present invention, and a winding wrapping on the magnetic core is omitted for clarity.

FIG. 3 illustrates a schematic diagram of a wiring of a winding on a single layer of a planar transformer and via holes that provide an interlayer electrical connection according to another preferred embodiment of the present invention.

FIG. 4A illustrates a schematic winding arrangement diagram of a primary side winding of a transformer (typically, a planar transformer as an example) including a winding with wrapped coils according to a preferred embodiment of the present invention, wherein the primary side winding includes only one pair of sub-windings to facilitate achievement of odd-numbered turns of primary side winding and an odd-numbered transformation ratio/equivalent primary side-secondary side turn ratio.

FIG. 4B illustrates a schematic winding arrangement diagram of a primary side winding of a transformer based on an extended preferred embodiment of the preferred embodiment illustrated of the present invention in FIG. 4A.

FIG. 5A illustrates a schematic winding arrangement diagram of a primary side winding of a transformer (typically, a planar transformer as an example) including a winding with wrapped coils according to another preferred embodiment of the present invention, wherein the primary side winding includes only one pair of sub-windings to facilitate achievement of odd-numbered turns of primary side winding and an odd-numbered transformation ratio/ equivalent primary side-secondary side turn ratio.

FIG. 5B illustrates a schematic winding arrangement diagram of a primary side winding of a transformer based on an extended preferred embodiment of the preferred embodiment of the present invention illustrated in FIG. 5A.

FIG. 6 illustrates a variation of preferred embodiments shown in FIGS. 4A to 4B according to the preferred embodiments of the present invention, wherein the primary side winding still includes only one pair of sub-windings whose main turns respectively wrap on even-numbered winding posts different from each other.

FIG. 7 illustrates a variation of preferred embodiments of the present invention shown in FIGS. 4A to 4B, wherein the primary side winding includes at least two pairs of sub-windings, sub-windings whose main turns defining the same magnetic flux direction in the at least two pairs of sub-windings are connected with each other in parallel, and main turns of two sub-windings in each pair of sub-windings respectively wrap on two winding posts different from each other.

FIGS. 8A to 8C illustrates a schematic diagram of a simulated thermal effect of a planar transformer according to a preferred embodiment of the present invention.

### DETAILED DESCRIPTION OF THE PREFERRED EMBODIMENTS

Technical solutions of the present disclosure will be further specifically described below through preferred embodiments and in combination with the accompanying drawings. In the specification, the same or similar reference numerals indicate components having the same or similar functions. The following descriptions of the preferred embodiments of the present invention with reference to the accompanying drawings are intended to explain the general concept of the present disclosure, and should not be construed as limiting the present disclosure. In addition, in the following detailed descriptions, for ease of explanation, numerous specific details are set forth in order to provide a comprehensive understanding of the preferred embodiments of the present invention. However, it may be obvious that one or more preferred embodiments may also be implemented without these specific details.

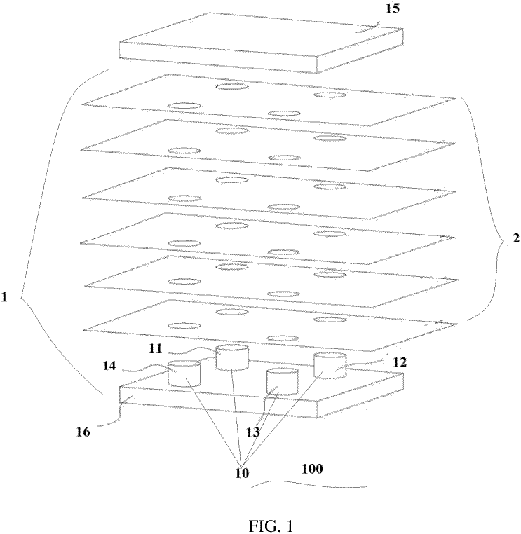

FIG. 1 schematically shows an exploded view of a three-dimensional structure of a planar transformer according to a preferred embodiment of the present invention.

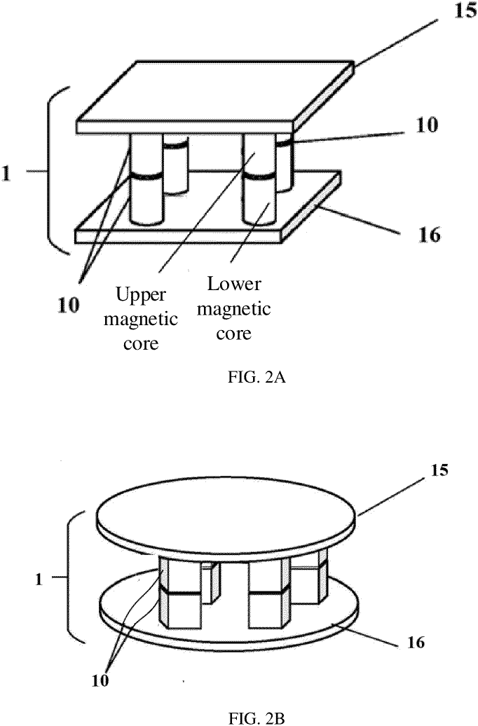

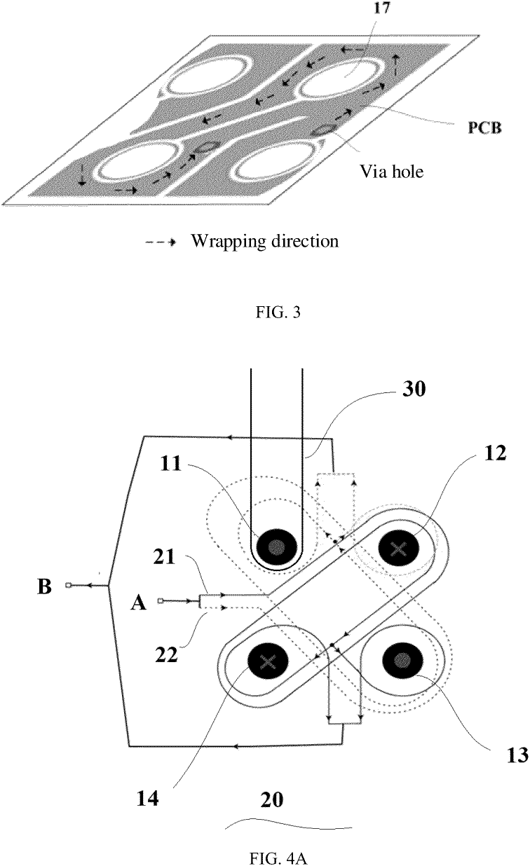

More specifically, FIG. 2A illustrates a schematic structural view of a magnetic core of a planar transformer 100 according to an preferred embodiment of the present invention, and a winding wrapping on the magnetic core 1 is omitted for clarity; FIG. 2B illustrates a schematic structural view of a magnetic core 1 of a planar transformer 11 according to another preferred embodiment of the present invention, and a winding wrapping on the magnetic core 1 is omitted for clarity; FIG. 3 illustrates a schematic diagram of a wiring of a winding on a single layer of a planar transformer 100 and via holes that provide an interlayer electrical connection according to another preferred embodiment of the present invention.

According to a general technical concept of a preferred embodiment of the present invention, for example, as shown in FIGS. 1-3, there is provided a planar transformer 100. The planar transformer 100 includes a magnetic core 1 and a winding 2. The magnetic core 1 includes a top substrate 15 and a bottom substrate 16 arranged opposite to each other, and a plurality of winding posts 10 located between the top substrate 15 and the bottom substrate 16. The winding 2 includes a primary side winding 20 and a secondary side winding 30. For example, the primary side winding 20 wraps around the plurality of winding posts 10. For example, as shown in FIG. 1, multiple layers of PCBs of the planar transformer are stacked to form an integral winding 2. As shown in FIG. 3, each layer of PCB of the planar transformer includes, for example, winding post windows 17 for the winding posts 10 to pass through, and portions of the winding on each layer of PCB wrap around the winding post windows 17, and the winding portions on the same layer are spaced apart from each other.

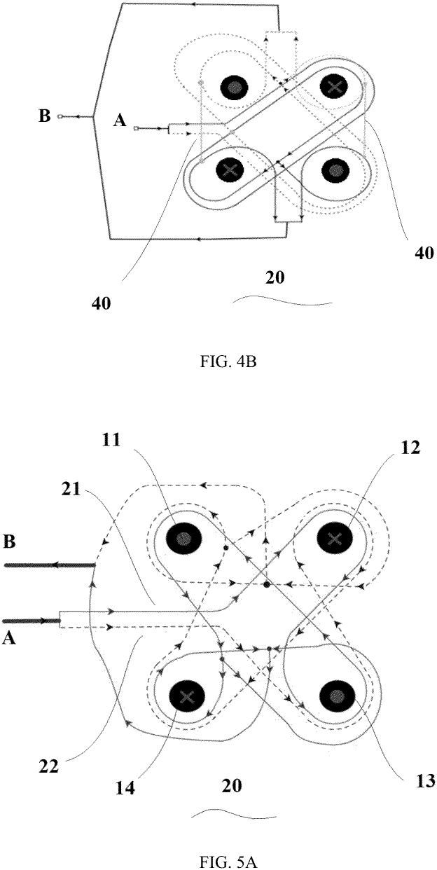

FIG. 4A illustrates a schematic winding arrangement diagram of a primary side winding 20 of a transformer (typically, a planar transformer 100 as an example) including a winding with wrapped coils according to a preferred embodiment of the present invention, which facilitates achievement of odd-numbered turns of primary side winding 20 and an odd-numbered transformation ratio/equivalent primary side-secondary side turn ratio; FIG. 4B illustrates a schematic winding arrangement diagram of a primary side winding 20 of a transformer based on an extended preferred embodiment of the preferred embodiment illustrated in FIG. 4A. A secondary side winding 30 is schematically shown in FIG. 4A, while a secondary side winding is omitted for clarity in FIG. 4B.

FIG. 5A illustrates a schematic winding arrangement diagram of a primary side winding 20 of a transformer (typically, a planar transformer 100 as an example) including a winding with wrapped coils according to another preferred embodiment of the present invention, which facilitates achievement of odd-numbered turns of primary side winding 20 and an odd-numbered transformation ratio/equivalent primary side-secondary side turn ratio; FIG. 5B illustrates a schematic winding arrangement diagram of a primary side winding 20 of a transformer based on an extended preferred embodiment of the preferred embodiment illustrated in FIG. 5A. A secondary side winding is omitted for clarity in FIGS. 5A and 5B.

In an exemplary preferred embodiment of the present invention, regarding a specific winding arrangement of the winding (especially the primary side winding 20) of the planar transformer 100 according to the preferred embodiment of the present invention, in order to facilitate a user to achieve the odd-numbered turns of winding of the planar transformer 100 and the odd-numbered turn ratio/transformation ratio, for example, as shown in FIGS. 4A to 4B and FIGS. 5A to 5B, the primary side winding 20 wraps around the plurality of winding posts 10. The primary side winding 20 includes, for example, at least one pair of sub-windings, each pair of sub-windings includes two sub-windings connected in parallel. Further, each sub-winding in each pair of sub-windings includes: a main turn and an additional turn. The main turn includes respective at least one turn respectively wrapping on at least two winding posts, and a current flowing through the main turn forms a main turn magnetic flux along a first magnetic flux direction on the at least two winding posts. The additional turn includes at least one turn reversely wrapping on at least one additional winding post with respect to the main turn, the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post.

Moreover, in each pair of sub-windings, a current of at least one main turn of each sub-winding is shunted to at least one additional turn of the same sub-winding, and a magnetic flux loss caused by a current shunting on a main turn of each sub-winding is compensated by a magnetic flux generated by a corresponding additional turn wrapping around the at least one main turn of the other sub-winding of the pair of sub-windings.

Through the above arrangement, substantially, in the two sub-windings connected in parallel with each other included in the primary side winding 20, for a current sub-winding, it not only provides at least one turn wrapping on at least two winding posts thereof as a main turn, but also additionally provides odd-numbered turns wrapping to an additional winding post in a parallel connection manner inside the sub-winding as additional turns, the other sub-winding different from the current sub-winding post wrapping on the additional winding post; and vice versa. Thereby, a corresponding additional turn of the other sub-winding substantially wraps on one of the winding posts on which the main turn of the current sub-winding wraps. Thereby, it may be learnt from a calculation based on Faraday’s law of electromagnetic induction and a voltage of the winding of the transformer known in the art that the additional turn in the other sub-winding additionally provides an additional magnetic flux to the current sub-winding for superposition with the magnetic flux of the main turn, so as to achieve a change in the transformation ratio and the primary side-secondary side equivalent turn ratio. In this way, it also facilitates an achievement of desired number of turns of primary side winding 20 or desired primary side-secondary side equivalent turn ratio as required, no matter the desired value is an odd number or an even number. Specifically, for example, the number of turns of primary side winding 20 is changed to an odd number, or the primary side-secondary side equivalent turn ratio is changed to an odd number.

In other words, in an exemplary preferred embodiment of the present invention, specifically, for example, as shown in the drawings, in the two sub-windings of the primary side winding 20 connected in parallel, a trunk current I_{P} of the primary side winding 20 is divided into a first sub-current I_{P1} and a second sub-current I_{P2} having an equal magnitude (I_{P1}=I_{P2}=I_{P/2}) . The first sub-current I_{P1} flows, for example, clockwise into a first sub-winding 21, and the second sub-current flows, for example, counterclockwise a second sub-winding 22. Thereby, as shown in the drawings, as an example, a single first magnetic flux direction (for example, a direction perpendicular to a paper surface and toward an inside of the paper surface as shown in the drawings) is formed on at least two winding posts (such as a second winding post 12 and a fourth winding post 14 in FIGS. 4A and 4B) on which a corresponding first main turn of the first sub-winding 21 wraps, and a corresponding second main turn of the second sub-winding 22 wraps on other winding posts (such as a third winding post 13 and a first winding post 11 in FIGS. 4A and 4B) different from the at least two winding posts of the plurality of the winding posts 10, and a reverse single second magnetic flux direction (for example, a direction perpendicular to the paper surface and toward an outside of the paper surface as shown in the drawings) is formed.

Meanwhile, as shown in the drawings, a corresponding second additional turn of the second sub-winding 22 substantially passes clockwise through at least one (for example, the second winding post 12 shown in FIGS. 4A and 4B) of the winding posts (as described above, the second winding post 12 and the fourth winding post 14) on which the corresponding first main turn of the first sub-winding 21 wraps to form a magnetic flux direction which is the same as the first magnetic flux direction of the winding posts (as described above, the second winding post 12 and the fourth winding post 14) of the first main turn of the first sub-winding 21, so that the second additional turn of the second sub-winding 22 substantially provides an additional magnetic flux (herein referred to as, for example, a first additional magnetic flux ) to the winding posts on which the first main turn of the first sub-winding 21 wraps for superimposition with the magnetic flux of the first main turn, so as to achieve a change in the transformation ratio and the primary side-secondary side equivalent turn ratio. In this way, it also facilitates the achievement of a desired number of turns of primary side winding 20, or a desired primary side-secondary side equivalent turn ratio as required, no matter if the desired value is an odd number or an even number. Specifically, for example, the number of turns of the primary side winding 20 is changed to an odd number, or the primary side-secondary side equivalent turn ratio is changed to an odd number.

Meanwhile, as shown in the drawings, a corresponding first additional turn of the first sub-winding 21 substantially passes counterclockwise through at least one (for example, the third winding post 13 shown in FIGS. 4A and 4B) of the winding posts (as described above, the third winding post 13 and the first winding post 11) on which the corresponding second main turn of the second sub-winding 22 wraps to form a magnetic flux direction which is the same as the second magnetic flux direction of the winding posts (as described above, the second winding post 12 and the fourth winding post 14) of the second main turn of the second sub-winding 22, so that the first additional turn of the first sub-winding 21 substantially provides an additional magnetic flux (herein referred to as, for example, a second additional magnetic flux ) to the winding posts on which the second main turn of the second sub-winding 22 wraps for superimposition with the magnetic flux of the second main turn, so as to achieve a change in the transformation ratio and the primary side-secondary side equivalent turn ratio. In this way, it also facilitates the achievement of desired number of turns of primary side winding 20, or desired primary side-secondary side equivalent turn ratio as required, no matter the desired value is an odd number or an even number. Specifically, for example, the number of turns of the primary side winding 20 is changed to an odd number, or the primary side-secondary side equivalent turn ratio is changed to an odd number.

In other words, in the primary side winding of the transformer according to the preferred embodiment of the present invention, as an example, an additional turn of one sub-winding wraps on a winding post (for example, referred to herein simply as a main winding post of the other sub-winding) on which a main turn of the other sub-winding wraps. Thereby, a magnetic flux generated on the main winding post of the other sub-winding by a corresponding portion of an excitation current flowing through the additional turn of the one sub-winding has a magnetic flux direction opposite to a magnetic flux direction on the winding post (i.e., a main winding post of the one sub-winding) on which the own main turn of the one sub-winding wraps, i.e., it substantially has a magnetic flux direction which is the same as a magnetic flux generated on the main winding post of the other sub-winding by a corresponding portion of an excitation current in the main turn of the other sub-winding. Thereby, a magnetic flux generated on the main winding post of the other sub-winding by a corresponding portion of an excitation current flowing through the additional turn of one sub-winding substantially contributes to a magnetic flux on the main winding post of the other sub-winding, and further contributes to a voltage value of the main winding post of the other sub-winding, and vice versa. That is: specifically, meanwhile, a magnetic flux generated on the main winding post of one sub-winding by a corresponding portion of an excitation current flowing through the additional turn of the other sub-winding substantially contributes to a magnetic flux on the main winding post of the one sub-winding, and further contributes to a voltage value of the main winding post of the one sub-winding.

As an example, a working principle of achieving the odd-numbered turns of primary side winding 20 or the odd-numbered primary side-secondary side equivalent turn ratio/ transformation ratio is briefly analyzed as follows.

The magnetic core 1 of the planar transformer 100 includes, for example, four winding posts. The four winding posts are, for example, arranged in a clockwise direction as shown in the drawings. According to the Faraday’s law of electromagnetic induction, it may be known that in a winding such as the primary side winding 20, for each winding post, a calculation formula of the magnetic flux generated by the excitation current flowing therethrough is typically as follows:

$$Φ = \frac{\left(N ∗ I\right)}{R} \qquad \text{(1)}$$

wherein Φ is a magnetic flux on a single winding post, N is a number of turns of an excitation coil wrapping on the single winding post, I is a current flowing through a specific turn flowing through the winding post, and R is a magnetic reluctance of the winding post. Correspondingly, for example, the four winding posts are, for example, respectively denoted as A₁, A₂, A₃, and A₄, magnetic reluctances thereof are respectively denoted as R₁, R₂, R₃, and R₄, and magnetic fluxes generated by the primary side winding 20 on the four winding posts are respectively denoted as Φ₁, Φ₂, Φ₃, and Φ₄.

Moreover, further, in a calculation of a voltage of the primary side winding 20, a calculation of a voltage on a single winding post on which the primary side winding wraps typically follows the formula:

$$U = \frac{d Φ}{d t} = \frac{d \left(\frac{N ∗ I}{R}\right)}{d t} = \frac{d \left(N ∗ I\right)}{R ∗ d t} \qquad \text{(2)}$$

wherein the calculation of the voltage on the single winding post of the winding such as the primary side winding 20 is substantially a differentiation of a magnetic flux of the single winding post with respect to time.

Obviously, due to a shunt relationship, a branch current flowing through a single-turn winding on each winding post must be a fraction of the trunk current Iₚ, for example,

$$I = {I}_{P} ∗ \left[\left(\frac{1}{Q}\right) ∗ \left(\frac{1}{{M}_{Q}}\right)\right] ,$$

wherein Q is a number of sub-windings, and Q=2 as shown in FIGS. 4A, 4B, 5A and 5B; M_{Q} is a number of parallel branches in a single sub-winding, i.e., a number of further shunted paths of the sub-winding (hereinafter referred to as a number of secondary branches corresponding to a number of winding posts on which branch currents wrap in parallel in a single sub-winding), and for example, as shown in FIGS. 4A, 4B, 5A and 5B, at each current branching position, and more specifically, at a primary branching position as shown in the drawings, a current is shunted equally, and so on, which will not be repeated here. In a typical example shown in FIGS. 4A, 4B, 5A and 5B, Q=2, N is a positive integer with a minimum value of 1, and a minimum value of R is, for example, a constant, then for a single winding post of the primary side winding 20, a minimum value of a magnetic flux Φ thereon should be

$${Φ}_{m i n} = \frac{{I}_{P}}{\left(2 ∗ R ∗ {M}_{Q}\right)} ,$$

and a minimum value of U should be

$${U}_{m i n} = \frac{d {I}_{P}}{\left(2 ∗ R ∗ {M}_{Q} ∗ d t\right)} .$$

It may thus be seen that a magnetic flux value on any winding post in the primary side winding 20 is an integer multiple of a minimum value Φₘᵢₙ; correspondingly, a voltage value on any winding post in the primary side winding 20 is an integer multiple of a minimum value Uₘᵢₙ.

It may be seen on this basis that, substantially, for a single current sub-winding in paired sub-windings, an additional turn on a winding post on which a main turn of the single sub-winding wraps additionally wraps in the other sub-winding, and, for example, in case that such additional turn in the other sub-winding being odd-numbered, it will result in an increase of a magnetic flux on the winding post of at least one main turn of the current sub-winding by an odd multiple of a minimum value Φₘᵢₙ, and an increase of a voltage value thereon by an odd multiple of a minimum value Uₘᵢₙ.

Therefore, in order to achieve desired odd-numbered turns on the primary side winding, for example, under a premise that a number of main turns thereof being an odd number, i.e., the main turn of each sub-winding wraps by odd-numbered turns, an additional turn of each sub-winding is required to wrap by odd-numbered turns on at least one winding post different from a winding post on which the main turn wraps.

According to a preferred embodiment of the present invention, for example, the preferred embodiment shown in FIG. 4A is taken as an example for illustration. In each pair of sub-windings, a magnetic flux loss caused by a current shunting on a main turn of one sub-winding is compensated by an additional turn of the other sub-winding. The main turn of the sub-winding 21 wraps on the winding posts 12 and 14, generating a magnetic flux toward an inside along a paper surface as shown in the drawings. Specifically, assuming a trunk current of a primary side winding is I_{P}, and a current initially entering the sub-winding 21 is a first sub-current I_{P1}, and I_{P1}=I_{P}/2. As shown in the drawings, the main turn of the sub-winding 21 wraps on the winding post 12 by two turns, and a current is the first sub-current I_{P1}; the main turn of the sub-winding 21 wraps on the winding post 14 by three turns, and there exists a situation that a current in the main turn wrapping on the winding post 14 is shunted to the additional turn of the sub-winding (the additional turn reversely wrapping on the winding post 13 on which a corresponding main turn of the other sub-winding 22 of the pair of sub-windings wraps), and thereby, a corresponding current in the main turn wrapping on the winding post 14 is I_{P1}/2=I_{P}/4. In total, a current generated in the main turn of the sub-winding 21 for generating a magnetic flux toward an inside along the paper surface is 4*(I_{P}/2)+1*(I_{P}/4)=9*I_{P}/4. However, in order to achieve the odd-numbered turns, such as 5 turns, in the primary side winding, actually, the magnetic flux of the main turn should be 5*(I_{P}/2), and therefore, there exists a magnetic flux loss to be compensated which is equal to a difference between the two.

Therefore, although a direct counting manner is performed on the main turn as shown in the drawings, and the main turn wraps by a total of 5 turns; however, in fact, it is necessary to consider that there exists a magnetic flux loss due to a current shunting in the main turn wrapping on the winding post 14 in a single time. Therefore, a compensation magnetic flux generated by a corresponding additional turn of the other sub-winding 22 in the same pair of sub-windings wrapping on the winding post 12 is then taken into account. Specifically, as shown in the drawings, the corresponding additional turn of the other sub-winding 22 in the same pair of sub-windings also generates a magnetic flux toward the inside along the paper surface on the winding post 12, which plays a role of compensating the magnetic flux loss due to the current shunting in the main turn wrapping on the winding post 14 in the sub-winding 21 as described above. Specifically, an additional turn of the other sub-winding 22 wraps by one turn on the additional turn on the winding post 14 on which the main turn of the sub-winding 21 is located, and a magnetic flux in the same magnetic flux direction as the main turn of the sub-winding 21 is generated, i.e., toward the inside along the paper surface. A current in the additional turn of the other sub-winding for compensating magnetic flux is half of the first sub-current I_{P2}, i.e., I_{P2}/2=I_{P1}/2=I_{P}/4.

Therefore, in fact, a sum of currents on the winding posts 12 and 14 on which the main turn of the sub-winding 21 wraps for generating the magnetic flux toward the inside along the paper surface is 9*I_{P}/4+I_{P2}/2=9*I_{P}/4+I_{P}/4=5* (I_{P}/2). That is, through the magnetic flux compensation of the additional turn of the other sub-winding 22 in the same pair of sub-windings, equivalent odd-numbered turns, i.e., five turns, of the primary side winding is achieved, so that that in each pair of sub-windings, a current of at least one main turn of each sub-winding is shunted to at least one additional turn of the same sub-winding, and a magnetic flux loss on the main turn of each sub-winding caused by a current shunting is compensated by a magnetic flux generated by a corresponding additional turn of the other sub-winding of the pair of sub-windings wrapping around the at least one main turn.

In this way, based on the above arrangement, in the primary side winding 20, for a single current sub-winding, a specific winding post on which an additional turn in the other sub-winding added on a main turn winding post of the current sub-winding wraps, a specific number of turns and a specific winding manner are flexibly selected as required, which facilitates achievement of desired number of turns of the primary side winding 20 or desired primary side-secondary side equivalent turn ratio, no matter the desired value is an odd number or an even number.

In a preferred embodiment of the present invention, the plurality of winding posts include, for example, 4T winding posts, where T is a positive integer. And as an example, in case that T=1, respective main turns of the two sub-windings wrap on two different winding posts, for example, as shown in FIGS. 4A to 5B.

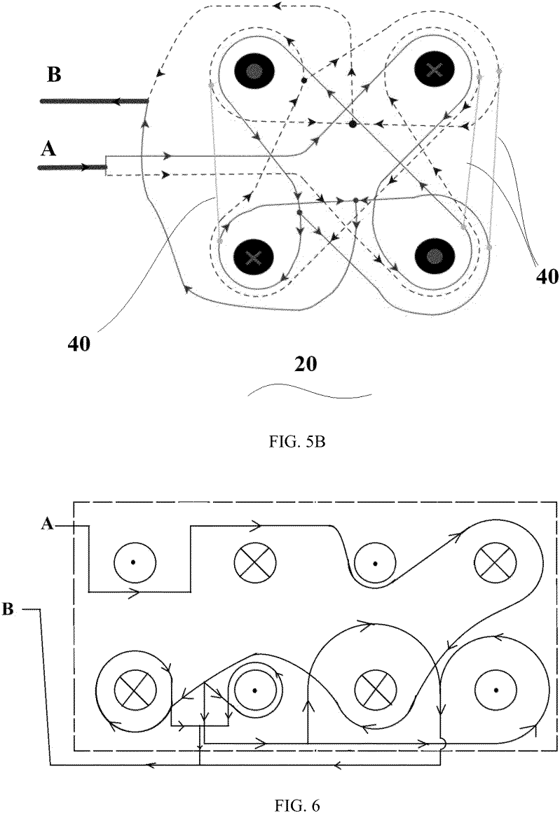

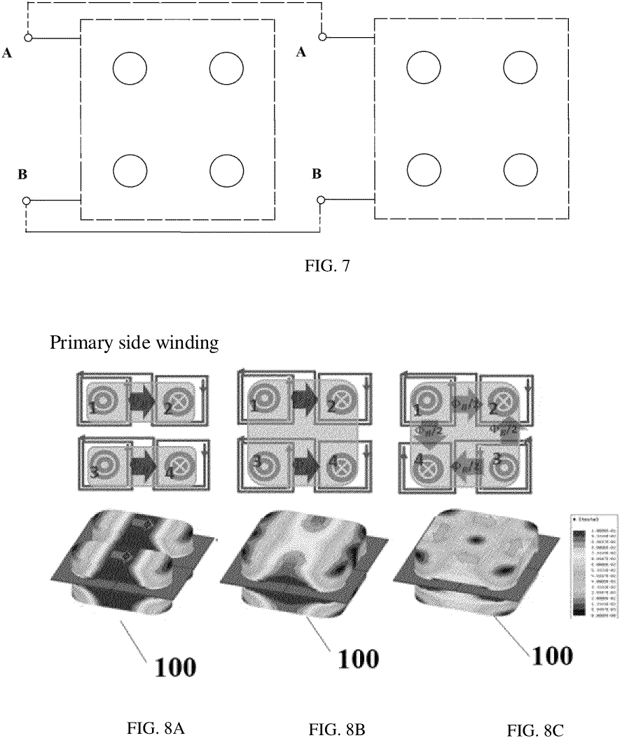

As a specific value of T increases, in a specific wrapping arrangement of windings, an actual arrangement of each sub-winding may be changed in more ways, for example, as shown in the extended preferred embodiments shown in FIG. 6 and FIG. 7 below.

In a further preferred embodiment of the present invention, for example, respective additional turns of the two sub-windings wrap by odd-numbered turns on at least one winding post different from the winding post on which respective main turns thereof wrap. Considering the above, a magnetic flux generated on the main winding post of the other sub-winding by a corresponding portion of an excitation current flowing through the additional turn of one sub-winding substantially contributes to a magnetic flux on the main winding post of the other sub-winding, and further contributes to a voltage value of the main winding post of the other sub-winding, and vice versa. That is, meanwhile, a magnetic flux generated on the main winding post of the one sub-winding by a corresponding portion of an excitation current flowing through the additional turn of the other sub-winding substantially contributes to a magnetic flux on the main winding post of the one sub-winding, and further contributes to a voltage value of the main winding post of the one sub-winding. In this way, as an example, the additional turn of each sub-winding wraps on at least one main winding post of the other different sub-winding by odd-numbered turns, so that odd-numbered turns of the primary side winding and odd-numbered transformation ratio/equivalent primary side-secondary side turn ratio may be achieved.

As a specific example, FIG. 4A schematically illustrates a schematic winding arrangement diagram of a primary side winding 20 of a planar transformer 100 according to an preferred embodiment of the present invention, which facilitates achievement of odd-numbered turns of the primary side winding 20 and odd-numbered transformation ratio/equivalent primary side-secondary side turn ratio. FIG. 5A schematically illustrates a schematic winding arrangement diagram of a primary side winding 20 of a planar transformer 100 according to another preferred embodiment of the present invention, which facilitate achievement of odd-numbered turns of the primary side winding 20 and odd-numbered transformation ratio/equivalent primary side-secondary side turn ratio.

In a specific exemplary preferred embodiment of the present invention, for example, as shown in FIG. 4A, in the primary side winding, the first additional turn of the first sub-winding 21 wraps on one main winding post 13 of the second sub-winding 22 by an odd-numbered turn such as one turn as shown in the drawing. A magnetic flux generated on the main winding post 13 of the second sub-winding 22 by a corresponding portion of an excitation current flowing through the first additional turn of the first sub-winding 21 substantially contributes to a magnetic flux on the main winding post 13 of the second sub-winding, and further contributes to a voltage value of the main winding post 13 of the second sub-winding 22, and vice versa. That is, meanwhile, the second additional turn of the second sub-winding 22 wraps on one main winding post 12 of the first sub-winding 21 by an odd-numbered turn such as one turn as shown in the drawing. A magnetic flux generated on the main winding post 12 of the first sub-winding 21 by a corresponding portion of an excitation current flowing through the second additional turn of the second sub-winding 22 substantially contributes to a magnetic flux on the main winding post 12 of the first sub-winding 21, and further contributes to a voltage value of the main winding post 12 of the first sub-winding 21. In this way, as an example, odd-numbered turns of the primary side winding and odd-numbered transformation ratio/equivalent primary side-secondary side turn ratio may be achieved by wrapping the additional turn of each sub-winding on the main winding post of the other different sub-winding by odd-numbered turns.

In another specific preferred embodiment of the present invention, for example, as shown in FIG. 5A, in the primary side winding, before each sub-winding wraps on the main winding posts arranged diagonally, it first wraps on an adjacent additional winding post (serving as a main winding post of the other sub-winding), and then transitioned to the main winding post, and once the wrapping on the main winding post thereof is completed, it wraps on yet additional winding post (also serving as a main winding post of the other sub-winding), and then transitioned and thereby electrically connected to the trunk circuit. In this way, the first main turn of the first sub-winding 21 substantially wraps on the main winding posts 13 and 11 thereof, and the second main turn of the second sub-winding 22 substantially wraps on the main winding posts 12 and 14 thereof. That is, each main winding post of each sub-winding shown in FIG. 5A is different from the situation shown in FIG. 5A.

Further, as shown in FIG. 5A, in the primary side winding, for example, the first additional turn of the first sub-winding 21 wraps on at least one of the main winding posts 12 and 14 of the second sub-winding 22 by odd-numbered turns (for example, as shown in the drawing, wrapping on the main winding post 12 of the second sub-winding 22 by odd-numbered turns such as one turn as shown in the drawing, and wrapping on another main winding post 14 of the second sub-winding 22 by even-numbered turns such as two turns as shown in the drawing). A magnetic flux generated on the main winding post of the second sub-winding 22 by a corresponding portion of an excitation current flowing through the first additional turn of the first sub-winding 21 substantially contributes to a magnetic flux on the main winding post of the second sub-winding, and further contributes to a voltage value of the main winding post of the second sub-winding 22, and vice versa. That is, meanwhile, the second additional turn of the second sub-winding 22 wraps on at least one of the main winding posts 13 and 11 of the first sub-winding 21 by odd-numbered turns (for example, as shown in the drawing, wrapped on one main winding post 13 of the first sub-winding 21 by odd-numbered turns such as one turn as shown in the drawing, and wrapping on another main winding post 11 of the first sub-winding 21 by even-numbered turns such as two turns as shown in the drawing). A magnetic flux generated on the main winding post of the first sub-winding 21 by a corresponding portion of an excitation current flowing through the second additional turn of the second sub-winding 22 substantially contributes to a magnetic flux on the main winding post of the first sub-winding 21, and further contributes to a voltage value of the main winding post of the first sub-winding 21. In this way, as an example, the additional turn of each sub-winding wraps on at least one main winding post (for example, odd-numbered main winding posts, typically for example, one main winding post) of the other different sub-winding by odd-numbered turns, so that odd-numbered turns of the primary side winding and odd-numbered transformation ratio/equivalent primary side-secondary side turn ratio may be achieved.

In a preferred embodiment according to the present invention, as shown in FIGS. 4A and 5A, as an example, the plurality of winding posts 10 are shown as four winding posts, connecting lines of center points of the four winding posts form a virtual quadrangle, wherein winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

In a preferred embodiment according to the present invention, the plurality of winding posts 10 are arranged on one of the bottom substrate 16 and the top substrate 15 and extending toward the other of the bottom substrate 16 and the top substrate 15. As an example, each winding post includes an upper magnetic core 1 and a lower magnetic core 1 bonded together or integrally formed as a single magnetic post. Further, as an example, the winding post is made, for example, of ferrite.

In a preferred embodiment according to the present invention, as shown in FIG. 4A, as an example, in case that the primary side winding 20sof four winding posts defining the virtual quadrangle, a specific winding manner is, for example, implemented as follows. The connecting lines of the center points of the first winding post 11, the second winding post 12, the third winding post 13, and the fourth winding post 14 form a quadrangle, the second winding post 12 and the fourth winding post 14 are located at two vertices on a first diagonal line (from upper right to lower left) of the quadrangle and serve as main winding posts of the first sub-winding 21 of the primary side winding 20; and the third winding post 13 and the first winding post 11 are located at two vertices on a second diagonal line (from bottom right to top left) of the quadrangle and serve as main winding posts of the second sub-winding 22 of the primary side winding 20.

In a more specific preferred embodiment according to the present invention, as an example, as shown in FIGS. 4A and 4B, the primary side winding 20 starts from a node A and is divided into two branches therefrom, i.e., the first sub-winding 21 and the second sub-winding 22 connected in parallel, they are respectively shown by a solid line path and a dotted line path, and finally merged to a node B.

In a preferred embodiment of the present invention, as shown in the drawings, as an example, winding directions of the first sub-winding 21 and the second sub-winding 22 are as shown in the drawings. For example, the first sub-winding 21 starts from the node A, and first respectively wrapping around the second winding post 12 and the fourth winding 14 by one turn in a clockwise direction in the first diagonal direction (from upper right to lower left), then wrapping around the second winding post 12 by another one turn in the clockwise direction, and then divided into two parallel secondary branches, one of which wraps around the fourth winding post 14 by one turn in the clockwise direction, and the other one of which wraps around the third winding post 13 by one turn in a counterclockwise direction (serving as the additional turn of the first sub-winding 21 and switching to the second diagonal direction, so as to increase the magnetic flux on the third winding post 13 serving as one of main turn winding posts of the second sub-winding 22 different from the first sub-winding 21, that is, the additional turn mainly plays a role of commutation). At last, the two parallel secondary branches are rejoined and electrically connected at the node B as an end point. It may be seen that the main turn winding posts of the first sub-winding 21 include the second winding post 12 and the fourth winding post 14, and directions of the magnetic fluxes on the two winding posts are perpendicular to the paper surface toward an inside.

Similarly, for example, the second sub-winding 22 also starts from the node A, and first respectively wrapping around the third winding post 13 and the first winding 11 by one turn in the counterclockwise direction in the second diagonal direction (from bottom right to upper left), then wrapping around the third winding post 13 by another one turn in the counterclockwise direction, and then divided into two parallel secondary branches, one of which wraps around the first winding post 11 by one turn in the counterclockwise direction, and the other one of which wraps around the second winding post 12 by one turn in the clockwise direction (serving as the additional turn of the second sub-winding 22 and switching to the first diagonal direction, so as to increase the magnetic flux on the second winding post 12 serving as one of main turn winding posts of the first sub-winding 21). At last, the two parallel secondary branches are rejoined and electrically connected at the node B as an end point. It may be seen that the main turn winding posts of the second sub-winding 21 include the third winding post 13 and the first winding post 11, and directions of the magnetic fluxes on the two winding posts are perpendicular to the paper surface toward an outside.

It may be seen that in the arrangement shown in FIGS. 4A and 4B, the first sub-winding 21 and the second sub-winding 22 in the primary side winding 20 are substantially arranged symmetrically with respect to each other. With the winding arrangement in the diagonal directions of the virtual quadrangle, for example, five turns on a side of the primary side winding 20 are achieved.

In the primary side winding 20 arrangement wrapping around the four winding posts arranged in a quadrangle, the above-mentioned specific arrangement facilitates flexible selections of a specific winding post on which an additional turn in the other sub-winding added on the main turn winding post of the current sub-winding wraps, a specific number of turns and a specific winding manner for a single current sub-winding, and facilitates the achievement of desired number of turns of the primary side winding 20 or desired primary side-secondary side equivalent turn ratio as required, for example, typically five turns on a primary side as shown in the drawing.

In a more specific alternative preferred embodiment according to the present invention, as an example, as shown in FIGS. 5A and 5B, the primary side winding 20 starts from a node A and is divided into two branches therefrom, i.e., the first sub-winding 21 and the second sub-winding 22 connected in parallel, they are respectively shown by a solid line path and a dotted line path, and finally merged to a node B.

In an exemplary preferred embodiment of the present invention, as shown in FIGS. 5A and 5B, as an example, winding directions of the first sub-winding 21 and the second sub-winding 22 are as shown in the drawings. For example, the first sub-winding 21 starts from the node A, and first wrapping around the second winding post 12 in a clockwise direction in the first diagonal direction, then switched to the second diagonal direction and wrapping around the third winding post 13 and the first winding post 11 in a counterclockwise direction, and then divided into two parallel secondary branches, one of which is switched back to the first diagonal direction to wrap around the fourth winding post 14 in a clockwise direction, and the other one of which wraps around the third winding post 13 in the counterclockwise direction further in the second diagonal direction (serving as the additional turn of the first sub-winding 21 to increase the magnetic flux on the main turn winding post of the second sub-winding 22 different from the first sub-winding 21). At last, the two parallel secondary branches are rejoined and electrically connected at the node B as an end point.

As shown in FIGS. 5A and 5B, as an example, the winding directions of the first sub-winding 21 and the second sub-winding 22 are as shown in the drawings, the second sub-winding 22 also starts from the node A and ends at the node B, and a winding arrangement of the second sub-winding is substantially symmetrical to the winding arrangement of the first sub-winding 21, which will not be repeated here.

It may be seen that, in the arrangement shown in FIGS. 5A and 5B, the first sub-winding 21 and the second sub-winding 22 in the primary side winding 20 are substantially arranged symmetrically with respect to each other. The winding arrangements in diagonal directions of the virtual quadrangle achieve, for example, five turns on a side of the primary side winding 20.

In the primary side winding 20 arrangement wrapping around the four winding posts arranged in a quadrangle, the above-mentioned specific arrangement facilitates flexible selections of a specific winding post on which an additional turn in the other sub-winding added on the main turn winding post of the current sub-winding wraps, a specific number of turns and a specific winding manner for a single current sub-winding, and facilitates the achievement of desired number of turns of the primary side winding 20 or desired primary side-secondary side equivalent turn ratio as required, for example, typically five turns on a side of the primary side winding 20 as shown in the drawing.

FIGS. 8A to 8C illustrate schematic diagrams of a simulated thermal effect of a planar transformer 100 according to a preferred embodiment of the present invention. FIGS. 8A and 8B are respectively simulation situations of two different cases in which wrapping is performed in an adjacent direction (i.e., an arrangement direction of winding posts with minimum spacing) instead of a diagonal direction, and FIG. 8C is a simulated situation in which odd-numbered turns of the primary side winding wrap in the diagonal direction as shown in FIGS. 4A, 4B, 5A and 5B.

In a preferred embodiment of the present invention, simulation results shown in FIGS. 8A and 8B are obtained by wrapping in an adjacent direction rather than a diagonal direction. In the case of such wrapping manner, for example, an arrangement and thickness of an upper sub-winding are consistent with those of a lower sub-winding, and a magnetic flux on each winding post only points toward an adjacent winding post without a magnetic flux shunting. Compared with the simulation results shown in FIG. 8A and FIG. 8B obtained by wrapping in the adjacent direction rather than the diagonal direction, a simulation result shown in FIG. 8C is obtained based on wrapping in the diagonal direction as shown in FIGS. 4A, 4B, 5A and 5B. As may be seen from the drawings, a magnetic flux on each winding post is shunted to two adjacent winding posts (typically, for example, shunted equally), and AC portions of the magnetic flux at least partially cancel with each other, thereby achieving a reduction, such as halving, of the thickness, i.e., an overall height as compared with the that in the simulation results shown in FIGS. 8A and 8B obtained by wrapping in the adjacent direction rather than the diagonal direction. For example, in the primary side winding 20, two sub-windings arranged symmetrically with respect to each other are arranged crosswise (for example, in an electrical parallel relationship) along the diagonal directions, and in the other sub-winding different from the current sub-winding, an additional turn belonging to the other sub-winding wrapping on the main turn winding post of the current sub-winding (based on an electrical connection relationship) is provided, so that the two sub-windings having opposite magnetic flux directions of the main turn cooperate with each other, thereby reducing the magnetic core 1 loss of the winding post, so that an overall height may be reduced.

In a preferred embodiment of the present invention, for example, as shown in FIGS. 4B and 5B, a short-circuit connection 40 is arranged between respective points of two sub-windings in paired sub-windings arranged symmetrically and having an equal electric potential. In fact, it is to connect respective equipotential points of two electrical networks separated from each other in a physical structure (in other portions except for electrical inlet and outlet), so as to increase a copper covered area (i.e., a larger copper laying area) without substantially changing the electrical connection relationship, thereby improving a thermal behavior and achieving a better overall heat dissipation as compared with cases shown in FIGS. 4A and 5A in which no short-circuit connection 40 is arranged. Due to the equal potential, the actual number of turns of winding and transformation ratio will not be affected. However, such arrangement may facilitate thermal conduction among different layers and optimize heat distribution, so as to achieve a more compact structure and a smaller transformer height.

In a preferred embodiment of the present invention, for example, the primary side winding 20 and the secondary side winding are arranged on multiple layers of the planar transformer 100 at intervals, and respective portions of the primary side winding and the secondary side winding arranged on different layers achieve an interlayer electrical communication to form an integral coil through connection in series or in parallel via a fly line passing through a via hole formed in at least one layer or a copper post connected among different layers. In this way, the primary side winding 20 is formed as the integral coil.

In a preferred embodiment, for example, as shown in the drawings, a cross section of each winding post is selected to be circular, oval, or square, but it is not limited thereto.

In a preferred embodiment, for example, a magnetic reluctance of each winding post is the same, but it is not limited thereto. Moreover, in a preferred embodiment, for example, a cross-sectional area of each winding post is the same, but it is not limited thereto. Coil wrapping of a transformer winding, especially a primary side winding based on multiple winding posts having the same magnetic reluctance and the same cross-sectional area facilitates achievement of an equalized magnetic potential in two symmetrical sub-windings arranged crosswise (for example, in an electrical parallel relationship) in the diagonal directions.

Through such an arrangement, it is convenient to simplify, for example, a calculation of the transformation ratio, or a calculation of, for example, the number of turns of the primary side winding 20 by converting the transformation ratio, i.e., the equivalent primary side-secondary side winding turn ratio.

As an example, the secondary side winding wraps around at least one winding post of the plurality of winding posts 10, and portions of the secondary side winding located on the same winding post wrap at intervals.

FIG. 6 illustrates a variation of preferred embodiments shown in FIGS. 4A to 4B according to the preferred embodiments, wherein the primary side winding still includes only one pair of sub-windings whose main turns respectively wrapping on even-numbered winding posts different from each other.

FIG. 7 illustrates a variation of preferred embodiments shown in FIGS. 4A to 4B, wherein the primary side winding includes at least two pairs of sub-windings, sub-windings whose main turns defining the same magnetic flux direction in the at least two pairs of sub-windings are connected with each other in parallel, and main turns of two sub-windings in each pair of sub-windings respectively wrapping on two winding posts different from each other.

As shown in FIG. 6 and FIG. 7, based on the preferred embodiments shown in FIGS. 4A to 4B, an application of the preferred embodiment of the present invention is further extended, especially for the case in which the plurality of winding posts include 4T winding posts, where T is a positive integer greater than or equal to 2. Both drawings illustrate the case of eight winding posts, i.e., T = 2.

According to an extended preferred embodiment of the present invention, for example, as shown in FIG. 6, the primary side winding includes only one pair of sub-windings whose main turns respectively wrapping on 2T, i.e., 8 winding posts different from each another. For ease of understanding, only one sub-winding of paired sub-windings is shown, while the other sub-winding is omitted. Substantially, the other sub-winding is arranged symmetrically with respect to the illustrated sub-winding. Compared with the sub-winding 21 in FIG. 4A, a wrapping manner of the single sub-winding shown in the drawing is slightly changed. The main turn additionally wraps on the second winding post from left to right in a first row and on the third winding post from left to right in a second row. The additional turn additionally wraps on the second and fourth winding posts from left to right in the second row. Substantially, the winding post equivalent to the winding post 12 in FIG. 4A is the fourth winding post from left to right in the first row, and the turn ratio of the primary side winding is still implemented as an odd number. In a specific preferred embodiment, for example, for a single sub-winding, secondary branches are implemented as four parallel branches in the second row respectively wrap on four winding posts in the second row.

According to another extended preferred embodiment of the present invention, for example, as shown in FIG. 7, the primary side winding includes at least two pairs of sub-windings. In such wrapping manner, paired sub-windings in each of FIGS. 4A to 4B are actually placed in a dotted box (i.e., shown in a black box method), then sub-windings whose main turns defining the same magnetic flux direction in the at least two pairs of sub-windings are connected with each other in parallel (a dotted line indicates a direct connection between two A terminals, and another dotted line indicates a direct connection between two B terminals), and main turns of two sub-windings in each pair of sub-windings respectively wrap on two winding posts different from each other. In this way, a current in each pair of sub-windings may be reduced at the same time, thereby improving heat generation and facilitating control of a dimension of the transformer.

The above example only illustrates the current shunting case that the current is at most shunted to secondary branches of a single sub-winding. However, in a further extended preferred embodiment, as an example, optionally, for example, in a single sub-winding, there may also exist higher-order branches further shunted based on currents of the secondary branches, such as third-level branches, and a smallest branch current correspondingly generates a minimum magnetic flux unit and a minimum voltage value unit. In this way, the magnetic flux value on any winding post in the primary side winding 20 is an integer multiple of the minimum magnetic flux unit. Correspondingly, the voltage value on any winding post in the primary side winding 20 is an integer multiple of the minimum voltage value unit. On this basis, specific odder-numbered or even-numbered main turns of the primary side winding, and specific odder-numbered or even-numbered primary side-to-secondary side turn ratio and transformation ratio may be selectively determined, which will not be repeated here again.

According to other preferred embodiments of the present invention, there is further provided a method for manufacturing a primary side winding 20 of a transformer (a transformer including a winding with wrapped coils, typically, a planar transformer 100 as an example). The planar transformer 100 includes a magnetic core 1 and a winding, the magnetic core 1 includes a top substrate 15 and a bottom substrate 16 arranged opposite to each other, and a plurality of winding posts 10 located between the top substrate 15 and the bottom substrate 16. The winding includes a primary side winding 20 and a secondary side winding. The method includes: preparing the magnetic core; and wrapping the winding of the transformer. The wrapping the winding of the transformer includes: wrapping the primary side winding 20 on the plurality of winding posts 10; and wrapping the secondary side winding on at least one of the plurality of winding posts 10. The wrapping the primary side winding 20 on the plurality of winding posts 10 includes: wrapping at least one pair of sub-windings, wherein each pair of sub-windings includes two sub-windings connected in parallel, and the wrapping at least one pair of sub-windings includes: wrapping a main turn, including respectively wrapping at least one turn on at least two winding posts, wherein a current flowing through the main turns forms a main turn magnetic flux along a first magnetic flux direction on the at least two winding posts; and wrapping an additional turn, including reversely wrapping at least one turn on at least one additional winding post with respect to the main turn, the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post.

In a preferred embodiment of the present invention, the plurality of winding posts, for example, include 4T winding posts, and as an example, respective main turns of the two sub-windings wrap on paired winding posts different from each other, where T is a positive integer.

In an extended preferred embodiment, for example, as shown in FIG. 6, the primary side winding includes only one pair of sub-windings, and main turns of the one pair of sub-windings respectively wrap on 2T winding posts different from each other.

In another extended preferred embodiment, for example, as shown in FIG. 7, the primary side winding includes at least two pairs of sub-windings, sub-windings whose main turns defining the same magnetic flux direction in the at least two pairs of sub-windings are connected with each other in parallel, and main turns of two sub-windings in each pair of sub-windings respectively wrap around two winding posts different from each other.

In a preferred embodiment according to the present invention, the at least two winding posts include paired non-adjacent winding posts, each sub-winding in each pair of sub-windings includes at least one turn respectively wrapping on the paired non-adjacent winding posts, and required odd-numbered or even-numbered turns wrapping on a winding post adjacent to one of the paired non-adjacent winding posts, a magnetic flux direction on each pair of non-adjacent winding posts is the same, which is opposite to a magnetic flux direction on the winding post adjacent to one of at least two non-adjacent winding posts.

In a preferred embodiment according to the present invention, in an exemplary method for manufacturing a transformer, for example, the plurality of winding posts 10 are prepared to be four winding posts as shown in the drawings, and connecting lines of center points of the four winding posts form a virtual quadrangle, winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

In a preferred embodiment of the present invention, in an exemplary method for manufacturing a transformer, for example, as shown in FIGS. 4B and 5B, a short-circuit connection 40 is arranged between respective points of two sub-windings in paired sub-windings arranged symmetrically and having an equal electric potential. In this way, it is to connect respective equipotential points of two electrical networks separated from each other in the physical structure (in other portions except for the electrical inlet and outlet), so as to increase the copper covered area without substantially changing the electrical connection relationship, thereby achieving a better overall heat dissipation as compared with the cases shown in FIGS. 4A and 5A in which no short-circuit connection 40 is arranged.

In a preferred embodiment according to the present invention, in an exemplary method for manufacturing a transformer, for example, the primary side winding 20 and the secondary side winding specifically wrap so that they being arranged on multiple layers of the planar transformer 100 at intervals, and respective portions of the primary side winding 20 and the secondary side winding arranged on different layers achieve an interlayer electrical communication to form an integral coil through connection in series or in parallel via a fly line passing through a via hole formed in at least one layer or a copper post connected among different layers. In this way, the primary side winding 20 is formed as the integral coil.

In a preferred embodiment according to the present invention, in an exemplary method for manufacturing a transformer, the secondary side winding wraps around at least one winding post of the plurality of winding posts, and portions of the secondary side windings located on the same winding post wrap at intervals.

In a preferred embodiment according to the present invention, in an exemplary method for manufacturing a transformer, for example, as shown in the drawings, a cross section of each winding post is manufactured to be circular, oval or square.

In a preferred embodiment according to the present invention, for example, a magnetic reluctance of each winding post is manufactured to be the same, but it is not limited thereto. Moreover, in a preferred embodiment, for example, a cross-sectional area of each winding post is manufactured to be the same, but it is not limited thereto. Coil wrapping of a transformer winding, especially a primary side winding based on multiple winding posts having the same magnetic reluctance and the same cross-sectional area facilitates achievement of an equalized magnetic potential in two symmetrical sub-windings arranged crosswise (for example, in the electrical parallel relationship) in the diagonal directions.

In a preferred embodiment according to the present invention, for example, the plurality of winding posts 10 are arranged on one of the bottom substrate 16 and the top substrate 15 and extending toward the other of the bottom substrate 16 and the top substrate 15. As an example, each winding post includes an upper magnetic core 1 and a lower magnetic core 1 bonded together or integrally formed as a single magnetic post. Further, as an example, the winding post is made, for example, of ferrite.

Regarding the method, since this method is used for forming the transformer described above, for example, the planar transformer 100 described above. Therefore, the method has all advantages of the planar transformer 100 described above, which will not be repeated here again.

The technical solutions provided by the present disclosure have the following advantages: the transformer and the method for manufacturing the transformer achieved by the preferred embodiments of the present invention, especially the method of wrapping the primary side winding thereof may, through the above-mentioned arrangements, achieve desired odd-numbered or even-numbered turns of winding and desired odd-numbered or even-numbered turn ratio/transformation ratio required in a transformer such as the planar transformer including the winding with wrapped coils. In addition, through at least two sub-windings arranged crosswise along diagonal directions (for example, in the electrical parallel relationship) and arranged symmetrically with respect to each other, the magnetic flux on each winding post is shunted to two adjacent winding posts (typically, shunted equally), and AC portions of the magnetic flux at least partially cancel with each other, thereby facilitating reduction such as halving of the overall thickness, i.e., the height. Moreover, for example, short circuit connections are provided at respective equipotential points of physically separated electrical networks, so that the copper covered area may be increased to improve thermal behaviors and overall heat dissipation performances. In this way, it is possible to improve the heat dissipation and reduce the dimensions such as the height while improving the power density, design parameters may be achieved with a more compact structure. Moreover, such compact structure minimizes a space occupation, and the simple structure and connection relationship facilitate assembly and disassembly.

Although the present disclosure has been described with reference to the accompanying drawings, the preferred embodiments disclosed in the accompanying drawings are intended to illustrate preferred embodiments of the present disclosure, and should not be construed as limiting the present disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A transformer comprising:
a magnetic core including:
a top substrate and a bottom substrate arranged opposite to each other; and
a plurality of winding posts located between the top substrate and the bottom substrate; and
a winding including a primary side winding and a secondary side winding, wherein
the primary side winding wraps around the plurality of winding posts, the primary side winding includes at least one pair of sub-windings, each pair of sub-windings includes two sub-windings connected in parallel, and each sub-winding in each pair of sub-windings includes:
a main turn including respective at least one turn wrapping on at least two winding posts, respectively, wherein a current flowing through the main turn forms a main turn magnetic flux along a first magnetic flux direction on the at least two winding posts; and
an additional turn including at least one turn reversely wrapping on at least one additional winding post with respect to the main turn, wherein the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post, and
in each pair of sub-windings, a current of at least one main turn of each sub-winding is shunted to at least one additional turn of a same sub-winding, and a magnetic flux loss caused by a current shunting on the main turn of each sub-winding is compensated by a magnetic flux generated by a corresponding additional turn wrapping around the at least one main turn of the other sub-winding of the pair of sub-windings.

2. The transformer according to claim 1, wherein
the plurality of winding posts include 4T winding posts, and T is a positive integer; and
the primary side winding includes one pair of sub-windings, and respective main turns of the pair of sub-windings respectively wrap on 2T winding posts different from each other, or
the primary side winding includes at least two pairs of sub-windings, respective main turns of sub-windings defining a same magnetic flux direction in the at least two pairs of sub-windings are connected in parallel with each other, and respective main turns of two sub-windings in each pair of sub-windings respectively wrap on two winding posts different from each other.

3. The transformer according to claim 1, wherein the main turn of each sub-winding wraps by odd-numbered turns, and the additional turn of each sub-winding wraps by odd-numbered turns on at least one winding post different from the winding posts on which the main turn wraps.

4. The transformer according to claim 1, wherein the at least two winding posts include paired non-adjacent winding posts, each sub-winding in each pair of sub-windings includes at least one turn respectively wrapping on the paired non-adjacent winding posts, and required odd-numbered or even-numbered turns wrapping on a winding post adjacent to one of the paired non-adjacent winding posts, a magnetic flux direction on each pair of non-adjacent winding posts is the same, which is opposite to a magnetic flux direction on the winding post adjacent to the one of paired two non-adjacent winding posts.

5. The transformer according to claim 1, wherein the plurality of winding posts are four winding posts, and connecting lines of center points of the four winding posts define a virtual quadrangle, winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

6. The transformer according to claim 1, wherein the plurality of winding posts are arranged on at least one of the bottom substrate and the top substrate and extend toward the other of the bottom substrate and the top substrate, and each winding post includes an upper magnetic core and a lower magnetic core bonded together or integrally formed as a single magnetic post.

7. The transformer according to claim 1, wherein a short-circuit connection is arranged between respective points of two sub-windings of each pair of sub-windings arranged symmetrically and having an equal electric potential.

8. The transformer according to claim 1, wherein the primary side winding and the secondary side winding are arranged on multiple layers of the transformer at intervals, and respective portions of the primary side winding and the secondary side winding arranged on different layers provide an interlayer electrical communication to form an integral coil through connection in series or in parallel via a fly line passing through a via hole in at least one layer or a copper post connected among different layers.

9. The transformer according to claim 8, wherein the secondary side winding wraps around at least one winding post of the plurality of winding posts, and portions of the secondary side windings located on a same winding post wrap at intervals.

10. The transformer according to claim 1, wherein a cross section of each winding post is circular, oval, or polygon.

11. The transformer according to claim 1, wherein a magnetic reluctance of each winding post is the same.

12. The transformer according to claim 1, wherein a cross-sectional area of each winding post is the same.

13. The transformer according to claim 1, wherein each winding post is made of ferrite.

14. A method for manufacturing a transformer, the transformer including a magnetic core and a winding, the magnetic core including a top substrate and a bottom substrate arranged opposite to each other, and a plurality of winding posts located between the top substrate and the bottom substrate, and the winding including a primary side winding and a secondary side winding, the method comprising:
preparing the magnetic core; and
wrapping the winding of the transformer including:
wrapping the primary side winding on the plurality of winding posts, and
wrapping the secondary side winding on at least one of the plurality of winding posts, wherein
the wrapping the primary side winding on the plurality of winding posts includes: wrapping at least one pair of sub-windings, wherein each pair of sub-windings includes two sub-windings connected in parallel, and the wrapping at least one pair of sub-windings includes:
wrapping a main turn including respectively wrapping at least one turn on at least two winding posts, wherein a current flowing through the main turn forms a main turn magnetic flux along a first magnetic flux direction on the at least two winding posts; and
wrapping an additional turn including reversely wrapping at least one turn on at least one additional winding post with respect to the main turn, wherein the at least one additional winding post is that on which the main turn of the other sub-winding of the pair of sub-windings wraps, and a current flowing through the additional turn forms an additional turn magnetic flux in a second magnetic flux direction opposite to the first magnetic flux direction on the at least one additional winding post, and
each pair of sub-windings wraps so that a current of at least one main turn of each sub-winding is shunted to at least one additional turn of a same sub-winding, and a magnetic flux loss caused by a current shunting on the main turn of each sub-winding is compensated by a magnetic flux generated by a corresponding additional turn wrapping on the at least one main turn of the other sub-winding of the pair of sub-windings.

15. The method according to claim 14, wherein the at least two winding posts include paired non-adjacent winding posts, each sub-winding in each pair of sub-windings includes at least one turn respectively wrapping on the paired non-adjacent winding posts, and required odd-numbered or even-numbered turns wrapping on a winding post adjacent to one of the paired non-adjacent winding posts, a magnetic flux direction on each pair of non-adjacent winding posts is the same, which is opposite to a magnetic flux direction on the winding post adjacent to the one of paired two non-adjacent winding posts.

16. The method according to claim 14, wherein the plurality of winding posts are four winding posts, and connecting lines of center points of the four winding posts define a virtual quadrangle, winding posts having a single magnetic flux direction are arranged at two vertices on one diagonal line of the virtual quadrangle, and winding posts having a magnetic flux direction opposite to the single magnetic flux direction are located at two vertices on the other diagonal line of the virtual quadrangle.

17. The method according to claim 14, a short-circuit connection is arranged between respective points of two sub-windings of each pair of sub-windings arranged symmetrically and having an equal electric potential.

18. The method according to claim 14, wherein the primary side winding and the secondary side winding are arranged on multiple layers of the transformer at intervals, and respective portions of the primary side winding and the secondary side winding arranged on different layers provide an interlayer electrical communication to form an integral coil through connection in series or in parallel via a fly line passing through a via hole in at least one layer or a copper post connected among different layers.

19. The method according to claim 18, wherein the secondary side winding wraps around at least one winding post of the plurality of winding posts, and portions of the secondary side windings located on a same winding post wrap at intervals.
